(19) United States
(12) Patent Application Publication
(10) Pub. No.: US 2007/0082665 A1
(43) Pub. Date: Apr. 12, 2007

(54) Handsfree device for a mobile telephone

(76) Inventor: Roman Piekarz, Mielec (PL)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/464,269

(22) Filed: Aug. 14, 2006

(30) Foreign Application Priority Data
Aug. 15, 2005 (DE) 10 2005 038 722.5

(51) Int. Cl. H04Q 7/20

(52) U.S. Cl. 455/426.1

(57) ABSTRACT

A handsfree device for conducting a telephone call which can be established by means of a mobile telephone, comprising a controller which is connected to a microphone and a loudspeaker, and with a communication link to a receiver which can be deposited in a holder with an electrical connection, wherein the telephone call is only conducted via the receiver by removing the receiver from the holder, enables the receiver to be used very flexibly due to the fact that the controller has a wireless communication device for communicating with a corresponding wireless first communication device of the receiver and the receiver is also provided with a wireless second communication device for communicating with a corresponding wireless communication device of the mobile telephone, with a device for processing access authorization data to a mobile radio network and with a telephone transmitting and receiving unit.

The invention relates to a handsfree device for conducting a telephone call which can be established by means of a mobile telephone, comprising a controller which is connected to a microphone and a loudspeaker, and with a communication link to a receiver which can be deposited in a holder with an electrical connection, wherein the telephone call is only conducted via the receiver by removing the receiver. The invention also relates to the use of the receiver of such a handsfree device.

It is known that handsfree devices are used for being able to conduct the telephone calls established via a mobile telephone without having to hold the telephone in one's hand. For this purpose, the audio signals of the telephone, but also control signals for establishing and ending the telephone call, are transmitted from the mobile telephone to the handsfree device and conversely so that the telephone call can be handled by means of microphone and loudspeaker connected to the controller of the handsfree device. Furthermore, the handsfree device normally enables the telephone call to be conducted via an external antenna connected to it, particularly a mobile radio car antenna.

It is also known that the voice of the caller does not have to be reproduced via the loudspeaker of the handsfree device if this is not desired by the person calling. For this purpose, the handsfree device can be provided with a receiver which can be deposited in a holder, wherein the removal of the receiver causes a signal which disconnects microphone and loudspeaker of the handsfree device so that the telephone call now only takes place via the receiver as a result of which those present can no longer hear the voice of the caller.

Numerous constellations are known for implementing such a handsfree system with a receiver which acts as so-called private receiver. In a very conventional manner, the mobile telephone itself forms the receiver in that it can be deposited in a holder in a motor vehicle. The telephone inserted into the holder activates the handsfree device. If the call is to be handled as a private call, the telephone used as receiver is taken from the holder as a result of which the reproduction of the telephone call via the loudspeaker is switched off. In this arrangement, the telephone is normally connected to the handsfree device via a cable link. However, it is also known to use a telephone equipped with a wireless communication device, preferably in accordance with the Bluetooth standard, which can communicate wirelessly with the handsfree device, wherein the transmitted signals are transmitted in standardized form as so-called “handsfree profile” (HFP). The disadvantageous factor is that the telephone must be inserted into a holder which is special to the telephone so that no other type of telephone can be used.

It is also known to connect a telephone to a handsfree device via a cable link, wherein the handsfree device has its own telephone transmitting and receiving unit in order to be able to conduct the telephone call in a motor vehicle via the mobile radio antenna installed in the motor vehicle. In this arrangement, an additional receiver can be provided which communicates with the handsfree device via a wireless communication device in order to be able to conduct a private call via the receiver. The call is then transmitted by HFP between receiver and handsfree device. In this arrangement, the receiver can additionally have a data link in order to control, that is to say set up, conduct or end the telephone call via keys and a display.

The present invention is based on the object of developing a handsfree device in such a manner that an improved and extended functionality can be achieved with the receiver.

To achieve this object, according to the invention, a handsfree device of the type initially mentioned is characterized in that the controller has a wireless communication device for communicating with a corresponding wireless first communication device of the receiver and that the receiver is also provided with a wireless second communication device for communicating with a corresponding wireless communication device of the mobile telephone, with a device for processing access authorization data to a mobile radio network and with a telephone transmitting and receiving unit.

The configuration of the handsfree device according to the invention is based on the finding that, although a conventional receiver, which is comfortably equipped, has a high functionality, it can only be used in the intended particular configuration of the handsfree device.

By comparison, an arrangement according to the invention of the handsfree device is suitable for using the receiver to form very different configurations so that the receiver can be used in many ways within quite different configurations of handsfree devices and, in addition, can be used as independent telephone outside the range of the handsfree device, that is to say, in particular, outside a motor vehicle.

For this purpose, the receiver can be equipped with a card reader for a card containing the access authorization data (SIM card). However, it is also possible that the second wireless communication device of the receiver is arranged for transmitting the access authorization data of the mobile telephone so that the access authorization data can be transmitted by means of the so-called rSAP standard.

The receiver is preferably provided with an input keypad and with a display in order to provide a full independent telephone function.

In the attached drawing, six examples using the receiver according to the invention are shown diagrammatically.

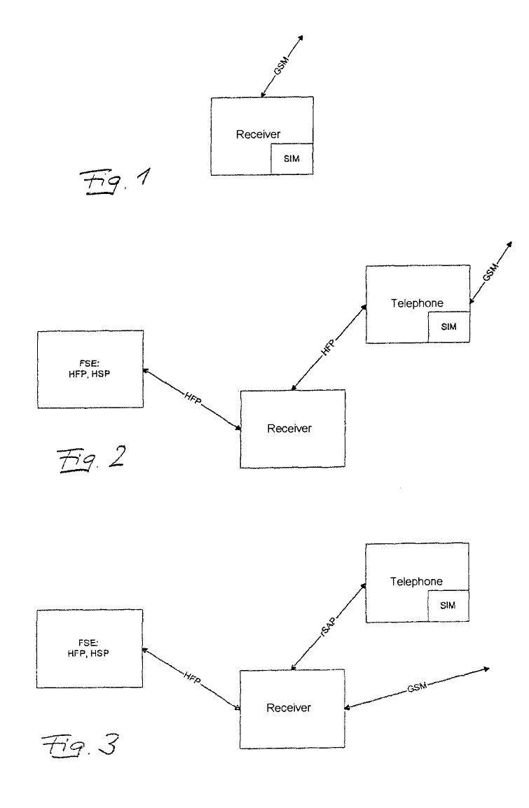

FIG. 1 shows the use of the receiver according to the invention as independent telephone, that is to say without a communication link to a handsfree device. For this purpose, a separate SIM card is used in the receiver which can be, for example, a twin card of a mobile telephone. The receiver of the handsfree device can thus be used as a mobile telephone which, for example, is always present in the motor vehicle and is always available outside the motor vehicle since the receiver is provided with its own telephone transmitting and receiving unit (shown here in accordance with the GSM standard).

According to FIG. 2, the receiver is used as connecting device between the mobile telephone via which a telephone link (GSM) is set up with the data of a SIM card and a handsfree device FSE preferably installed in the motor vehicle. The handsfree device is provided with a wireless communication device by means of which audio data and control data can be transmitted in accordance with the headset profile (HSP). Transmission to the receiver is effected here by means of HFP. From the receiver, a second transmission of HFP takes place to the telephone. The receiver thus virtually acts as a relay between telephone and handsfree device FSE and thus allows it to function as private receiver.

According to FIG. 3, the receiver's own telephone transmitting and receiving device (GSM) is used for setting up a telephone call. The setting up is done by means of the access authorization data (SIM) transmitted by the telephone in rSAP to a mobile radio network. The receiver is connected to the handsfree device FSE via HFP and makes use of the possibility of conducting the call via the handsfree device or as private call via the receiver. Since the receiver is conducting the telephone call, the telephone is loaded only slightly with respect to the current consumption in order to maintain the data link according to rSAP. The current consumption which is increased for transmitting and receiving during the telephone call takes place in the receiver which can be continuously charged up in its holder from the power supply of the motor vehicle. When the holder is connected to the mobile radio car antenna, the transmit and receive signals of the receiver can be radiated or received, respectively, via this external antenna as a result of which radiation loading in the interior space of the motor vehicle can be avoided in handsfree operation even though the handsfree device itself is not equipped with its own telephone transmitting and receiving unit.

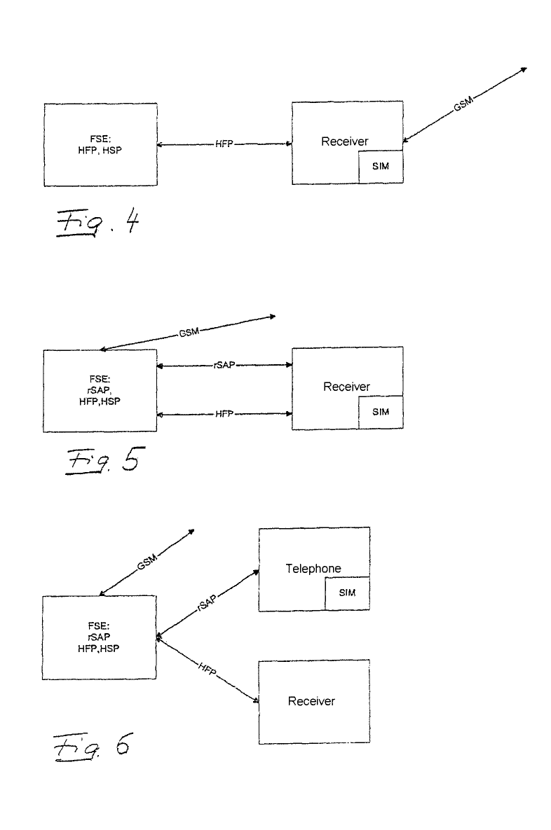

In the constellation shown in FIG. 4, the receiver is directly used as mobile telephone with its own SIM card. The receiver is wirelessly connected to the handsfree device FSE via HFP.

A similar constellation is found in FIG. 5 in which the receiver virtually acts as SIM card server for the handsfree device FSE so that the call can be conducted within the mobile radio network using the access data of the SIM card inserted into the receiver, via a separate telephone transmitting and receiving device of the FSE, in particular via the mobile radio car antenna. For the private listening function, the receiver is additionally connected to the FSE via HFP.

According to FIG. 6, the receiver has the exclusive function of using it to conduct a private call which is conducted by the handsfree device FSE by means of its own telephone transmitting and receiving unit by means of the SIM card data of the mobile telephone which have been transmitted to the handsfree device FSE via rSAP.

It can be seen that none of the configurations shown require any changes in the receiver constructed according to the invention since it only communicates, and functions, with the handsfree device FSE and possibly with the mobile telephone via the wireless communication devices. Accordingly, all configurations can also be used with any mobile radio telephones for which no specific devices need to be provided, for example in a motor vehicle. Instead, it is only of importance that the receiver performs an initialization of the wireless communication (via Bluetooth) with the handsfree device FSE, on the one hand, and possibly with the mobile telephone, on the other hand, in order to provide for an immediately operative Bluetooth link when, for example, the mobile telephone is intended to enter into a desired configuration with the handsfree device FSE.

The functionality of the receiver can be used at any time, possibly also as separate mobile telephone which is always available in the holder of the motor vehicle —and then can be preferably charged up—and can be removed from it when the user of the motor vehicle also needs to use a mobile telephone outside the motor vehicle.

1. A handsfree device for conducting a telephone call which can be established by means of a mobile telephone, comprising a controller which is connected to a microphone and a loudspeaker, and with a communication link to a receiver which can be deposited in a holder with an electrical connection, wherein the telephone call is only conducted via the receiver by removing the receiver from the holder, wherein the controller has a wireless communication device for communicating with a corresponding wireless first communication device of the receiver and the receiver is also provided with a wireless second communication device for communicating with a corresponding wireless communicating device of the mobile telephone, with a device for processing access authorization data to a mobile radio network and with a telephone transmitting and receiving unit.

2. The handsfree device as claimed in claim 1, wherein the receiver is equipped with a card reader for a card containing the access authorization data 9SIM card).

3. The handsfree device as claimed in claim 1, wherein the second communication device is arranged for transmitting the access authorization data of the mobile telephone.

4. The handsfree device as claimed in claim 1, wherein the receiver is provided with an input keypad.

5. The handsfree device as claimed in claim 1, wherein the receiver is provided with a display for displaying telephone data.

6. The handsfree device as claimed in claim 2, wherein the receiver is arranged with its own voltage source.

7. The handsfree device as claimed in claim 6, wherein the voltage source of the receiver is formed by a battery which can be charged up when the receiver is inserted in to the holder.

8. The use of the receiver of the handsfree device as claimed in claim 6 as an independent mobile telephone.
